(19) United States
(12) Patent Application Publication
(10) Pub. No.: US 2023/0096794 A1
(43) Pub. Date: Mar. 30, 2023

(54) METHOD FOR MANUFACTURING A FREE-FORM OPTICAL COMPONENT

(71) Applicant: Robert Bosch GmbH, Stuttgart (DE)

(72) Inventor: Stephan Geise, Ruethen (DE)

(21) Appl. No.: 17/951,307

(22) Filed: Sep. 23, 2022

(30) Foreign Application Priority Data
Sep. 30, 2021 (DE) 10 2021 211 017.7

(51) Int. Cl. B29D 11/00; G02B 27/00

(52) U.S. Cl. CPC B29D 11/0074; G02B 27/0006; B29D 11/00865; B29K 2995/0026; G01S 7/4813

(57) ABSTRACT

A method for manufacturing a free-form optical component in an injection unit and a painting tool including at least one cavity. Initially, the manufacturing of the free-form optical component as a cover plate takes place by injection molding or injection embossing of a transparent plastic material in the injection unit. The introduction then takes place of a laser-transparent, opaque paint material into a one-sided gap between the cover plate and a boundary of the first cavity of the painting tool. The treated cover plate is turned into a second cavity of the painting tool and the introduction of a self-healing paint layer into the second cavity takes place in such a way that a gap surrounding the treated cover plate is completely filled by the self-healing plastic material and surrounds the free-form optical component.

### FIELD

The present invention relates to a method for manufacturing a free-form optical component in an injection unit and a painting tool including at least one cavity. Furthermore, the present invention relates to the use of the method for manufacturing a free-form optical component to protect a sensor from weather influences, stone impact, and/or soiling.

### BACKGROUND INFORMATION

U.S. Patent Application Publication No. US 2015/0225598 A1 relates to a coating film including a carrier substrate and a first layer, which is applied on one side of the carrier substrate and which includes a first, curable, cross-linking copolymer. Furthermore, a second layer is described, which is applied to the other side of the carrier substrate and includes a second, curable, cross-linking copolymer including inorganic particles therein.

U.S. Patent Application Publication No. US 2018/0217242 A1 relates to a LIDAR sensor including a housing and a first sensor window and a second sensor window. An optical sensor and a laser radiation source are provided. The first window has a first property for repelling water, the second window has a second property for repelling water which differs from the first-mentioned water repellent property. A laser beam which is incident through the first window may be generated with the aid of the laser source. One or multiple processors are provided, which receives sensor data from the optical sensor and determines that an optical interference is located on the surface of at least the first window.

German Patent Application No. DE 10 2011 122 341 A1 describes a LIDAR cover plate in which a heating conductor is applied by a metallization method to a film. The film is situated in the receiving window and connected to the carrier plastic by a back injection molding process using a black and laser-transparent thermoplastic material. In this method, the fixing of the film in the injection molding tool is very complex so that all heating conductors remain at the correct position during the injection process including corresponding cavity pressure. In addition, the film or the carrier also has to be covered using a protective lacquer in a downstream process step. Since the costly plastic of the plate is colored black for reasons of vision protection, it accordingly expands upon introduction of heat, for example, due to the solar radiation, and changes the optical free-form surface geometry.

German Patent Application No. DE 10 2013 012 785 A1 describes a wire device between thermoplastic films as a heating or antenna device. This is subsequently back injection molded using a thermoplastic melt, which is also colored black, and molded into a cover plate for a radar module. The plastics used do not have to be optically transparent in this case, but only permeable for the electromagnetic radar waves. This component subsequently requires at least one additional scratch protection layer.

German Patent Application No. DE 10 2015 218 876 A1 describes thermoplastic films including integrated copper tracks which are back injection molded using a dark-colored thermoplastic and thus produce a heatable cover plate for a radar module. An additional scratch protection layer is applied in a downstream process step for use at the vehicle.

### SUMMARY

According to the present invention, a method is provided for manufacturing a free-form optical component, using an injection unit and a painting tool including at least one cavity. According to an example embodiment of the present invention, the method includes:
a) manufacturing the free-form optical component as a cover plate by injection molding or injection embossing of a transparent plastic material in the injection unit,
b) introducing a laser-transparent, opaque paint material into a one-sided gap between the cover plate and a boundary in a first cavity of the painting tool,
c) turning the cover plate treated according to b) into a second cavity of the painting tool and introducing a self-healing paint material into the second cavity in such a way that a gap surrounding the cover plate treated according to b) is completely filled by the self-healing paint material and encloses the free-form optical component.

A cost-effective and opaque cover plate for a sensor, in particular a LIDAR sensor including a self-healing outer layer, may advantageously be manufactured by the approach provided according to the present invention. In a short cycle time and in few process steps, this component may be manufactured reproducibly from laser-transparent plastics as a free-form optical component including uniform surfaces.

In one refinement of the approach provided according to the present invention, according to method step a), transparent plastic material, a standard thermoplastic, a polycarbonate (PC), or a polymethyl methacrylate (PMMA) is used.

In one refinement of the approach provided according to the present invention, the free-form optical component is manufactured for a 180° field of view and essentially tension-free. The field of view of, for example, a LIDAR sensor thus remains essentially unimpaired. Furthermore, the freedom from tension lengthens the service life of the free-form optical component not insignificantly.

In one advantageous refinement of the approach provided according to the present invention, the laser-transparent, opaque paint material supplied according to b) adheres on one side, in particular a later outer side of the free-form optical component or on a wire mesh or on a heating film.

In one advantageous refinement of the approach provided according to the present invention, the laser-transparent, opaque paint material supplied according to b) cross-links due to the supply of heat or UV radiation. Upon corresponding heating of the painting tool, the free-form optical component in the form of a cover plate may be removed completely manufactured and then installed.

In the method provided according to the present invention, according to c), a clear polyurethane paint, which is self-healing upon the supply of heat, is used as the self-healing paint material.

In one advantageous refinement of the approach provided according to the present invention, according to c), the clear self-healing polyurethane paint used with the supply of heat and the use of UV radiation, is injected completely around the free-form optical component, which is manufactured from transparent plastic material, including an opaque outer side.

In the method provided according to an example embodiment of the present invention, the one-sided gap extends in a gap width between 0.1 mm and 0.3 mm between the outer side of the free-form optical component in the form of the cover plate, on the one hand, and the surface of the nozzle-side mold insert on the painting tool, on the other hand.

After curing of the laser-transparent, opaque paint material at the outer side of the free-form optical component, it is turned from the first cavity of the painting tool into its second cavity.

After the insertion of the free-form optical component into the second cavity of the painting tool, the gap enclosing the free-form optical component placed in the second cavity extends in such a way that it encloses the free-form optical component in a gap width in relation to the nozzle-side mold insert and to the ejector-side mold insert between 0.1 mm and 0.3 mm.

The clear, self-healing, polyurethane-based paint material is advantageously injected into the surrounding gap on both sides of the free-form optical component into the gap surrounding it and chemically cross-links at a temperature between 140° C. and 180° C.

In addition, the present invention relates to the use of the method for manufacturing a free-form optical component for protecting a sensor from weather influences, stone impact, and/or soiling.

Using the manufacturing method provided according to the present invention, a cost-effective and opaque free-form optical component in the form of a cover plate for use on a sensor, for example, a LIDAR sensor, including a self-healing outer layer, may be manufactured in an advantageous manner. With a short cycle time and in few process steps, the free-form optical component may be manufactured reproducibly from laser-transparent plastics including uniform surfaces. By way of the cover plate manufactured in the first method step from the transparent plastic material, a free-form optical component is obtained tension-free for a 180° view by injection molding or injection embossing. Fastening points may also be molded directly on the free-form optical component, without a further manufacturing step being required for this purpose. The transparent plastic material may in general be a cost-effective standard material, since an opaque pigmentation of the free-form optical component for vision protection is applied using a thin pigmented paint layer in the following method step. The thermoplastic component manufactured from transparent plastic material thus only absorbs little thermal energy, for example, in direct solar radiation and remains essentially dimensionally stable.

In the subsequent second method step, in the method provided according to the present invention, an opaque and nonetheless laser-transparent, preferably thermosetting, paint material is poured into a thin gap between the front side of the free-form optical component (a thermoplastic component) and the tool cavity. This transparent and opaque paint material adheres very well to the free-form optical component manufactured from the thermoplastic in the form of the cover plate. Alternatively, the opaque and laser-transparent paint material also adheres very well to an alternatively usable wire mesh or a heating film. Chemical cross-linking of the laser-transparent and opaque paint material takes place either due to the supply of heat or due to application of UV radiation.

In a subsequent third method step, a clear, polyurethane-based lacquer material, which represents a self-healing surface upon the supply of heat, is injected completely around the free-form optical component manufactured from transparent plastic material on its opaque, but laser-transparent outer side. Irregularities due to different shrinkage areas on the component may thus be compensated and a uniformly extending component surface may be achieved.

Due to the method provided according to the present invention, after running through fewer process steps, a free-form optical component having an opaque outer side or front side may be manufactured in the form of a cover plate. Scratches possibly resulting thereon on the inner side and the outer side may be eliminated by self-healing due to the supply of heat or UV irradiation, so that a uniform surface is achieved which again offers a clear view for a laser radiation source.

Following the approach provided according to the present invention, all manufacturing processes may be carried out in the closed injection molding tool or painting tool, so that accordingly fewer error sources result. A further advantage, which is not to be assessed as minor, of the approach provided according to the present invention is the circumstance that later errors during the installation or occurring scratches may be remedied automatically, and that an easy color changeover is possible, so that adjustments to the particular vehicle color may be carried out without problems.

### BRIEF DESCRIPTION OF THE DRAWINGS

Specific embodiments of the present invention are explained in more detail on the basis of the figures and the following description.

FIG. 1 shows a schematic representation of the components of a sensor system, a LIDAR system here.

FIG. 2 shows a schematic diagram of an injection molding or injection embossing tool for manufacturing the free-form optical component from a transparent plastic material, according to an example embodiment of the present invention.

FIG. 3 shows the schematic diagram of a two-cavity painting tool for manufacturing an opaque side of the free-form optical component, according to an example embodiment of the present invention.

FIG. 4 shows the schematic diagram of a two-cavity painting tool including a representation of the self-healing paint material completely enclosing the free-form optical component, according to an example embodiment of the present invention.

FIG. 5 shows the schematic diagram of the complete two-cavity painting tool, according to an example embodiment of the present invention.

### DETAILED DESCRIPTION OF EXAMPLE EMBODIMENTS

In the following description of the specific embodiments of the present invention, identical or similar elements are identified by identical reference numerals, a repeated description of these elements being omitted in individual cases. The figures only schematically represent the subject matter of the present invention.

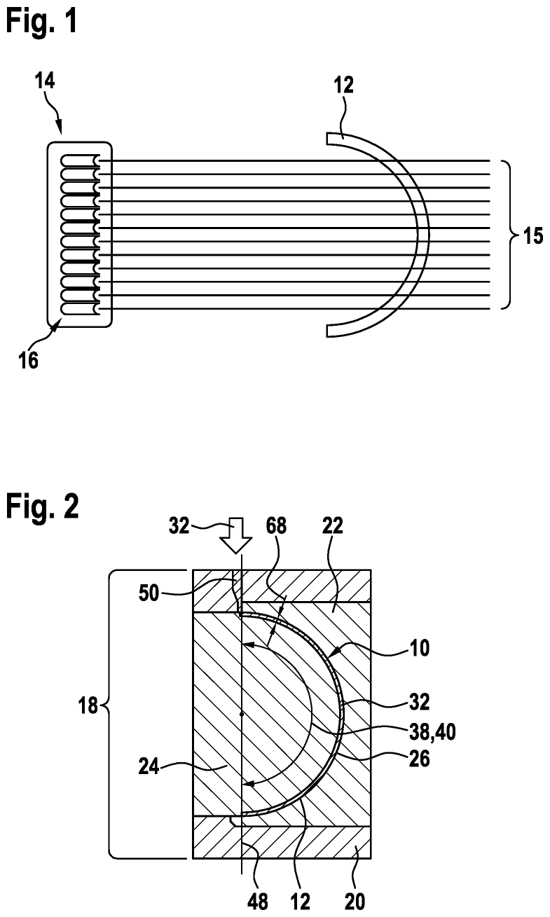

FIG. 1 shows a LIDAR sensor 14, which includes a diode array 16. This is irradiated from one side using a bundle of a laser radiation 15. Laser radiation 15 passes a cover plate 12, according to an example embodiment of the present invention.

A schematic representation of an injection molding or injection tool 20 may be seen in the representation according to FIG. 2. It is apparent from FIG. 2 that an injection unit 18 is divided along a parting plane 48 into a nozzle-side mold insert 22 and an ejector-side mold insert 24 opposite thereto. Mentioned mold inserts 22, 24 may be divided along parting plane 48, so that a component manufactured in injection unit 18 in the form of a free-form optical component 10, formed as cover plate 12, may be demolded, i.e., may be removed from injection unit 18.

In closed injection unit 18 shown in FIG. 2, mentioned mold inserts 22, 24 are formed using an injection tool 20. In the closed state of mold inserts 22, 24, a cavity results, into which a transparent plastic material 32 is injected via a sprue 50. Due to the geometry of the cavity, a free-form optical component 10 describing a 180° arc 38 in the form of a cover plate 12 results. On an outer side 26, cover plate 12 faces toward nozzle-side mold insert 22. Cover plate 12 has an essentially spherical shape 40 and is formed in a first layer thickness 68, which results from the geometry of the cavity, which arises in the closed state due to the adjoining areas of nozzle-side mold insert 22 and ejector-side mold insert 24.

In injection tool 20 schematically shown in FIG. 2, nozzle-side mold insert 22 and ejector-side mold insert 24 for manufacturing free-form optical component 10 in the form of cover plate 12 from transparent plastic material 32 are manufactured to form the corresponding free-form surfaces and the required low surface roughness, preferably in the ultra-precision machining method. The two mold inserts 22, 24 are inserted into injection tool 20 and this is accommodated in injection unit 18. Via injection unit 18, the liquid plastic melt in the form of transparent plastic material 32 is poured via sprue 50 and a gate into the resulting cavity. Transparent plastic material 32 is, for example, a standard thermoplastic, a polycarbonate (PC), for example, Makrolon® from Covestro, which is also used to manufacture front plates in headlights. An alternative material is, for example, polymethyl methacrylate (PMMA) having the designation Plexiglas from Evonik or a styrene-acrylonitrile copolymer (SAN). During the manufacturing of free-form optical component 10 according to FIG. 2, fastening points for the integration in a system housing may be molded on in the outer areas of obtained cover plate 12. After a cooling time, mold inserts 22, 24 open along parting plane 48, so that injection molded free-form optical component 10 configured as a cover plate 12 may be removed.

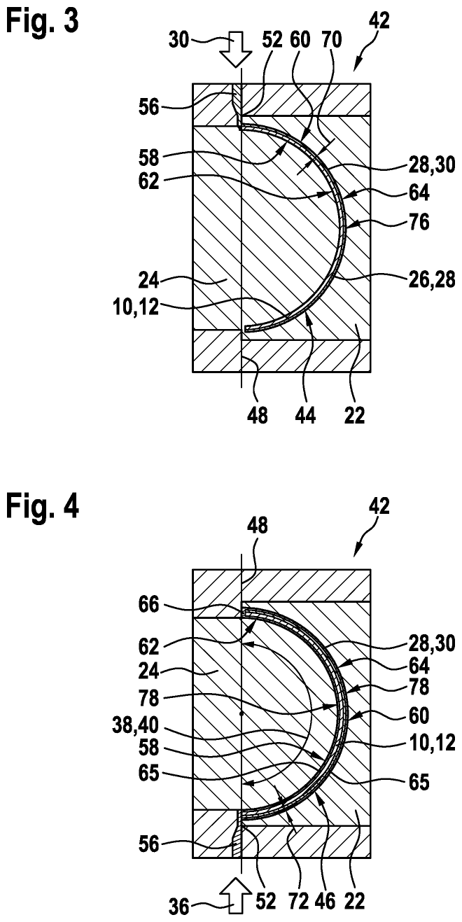

FIG. 3 shows a schematic representation of a first cavity of a two-cavity painting tool.

It is apparent from FIG. 3 that cover plate 12 produced as a free-form optical component 10 obtained according to FIG. 2 is inserted in a first cavity 44 of a two-cavity painting tool 42. After corresponding closing of nozzle-side mold insert 22 and ejector-side mold insert 24, a gap 76 extending on one side results due to the geometry of first cavity 44 on outer side 26 of free-form optical component 10 made of transparent plastic material 32. The gap width of one-sided gap 76 extending along outer side 26 of cover plate 12 is between 0.1 mm and 0.3 mm. A laser-transparent, opaque paint material 30 is injected into this gap according to the illustration in FIG. 3. A laser-transparent, but opaque coating is thus produced on outer side 26 of cover plate 12, as which free-form optical component 10 is designed here by way of example. This coating has a second layer thickness 70. A laser-transparent, but opaque front side 28 thus results on cover plate 12 on a convex curve 58, while a concave curve 60 of free-form optical component 10 formed as cover plate 12 still remains uncoated in this case.

After the opening of first cavity 44 of two-cavity painting tool 42, free-form optical component 10, which now has an opaque front side 28 on its outer side 26 and is formed as cover plate 12, is moved via a handling device into a second cavity 46, as schematically indicated in FIG. 4.

Second cavity 46 of two-cavity painting tool 42 may be seen in the illustration according to FIG. 4. If cover plate 12 provided with an opaque front side 28 according to FIG. 3 is transferred into second cavity 46 of two-cavity painting tool 42 shown in FIG. 4, nozzle-side mold insert 22 and ejector-side mold insert 24 are closed. The geometry of mold inserts 22, 24 is dimensioned in such a way that in the inserted state of free-form optical component 10 including opaque front side 28, a gap 78 completely surrounding it results. In the closed state of second cavity 46, free-form optical component 10 including opaque front side 28 made of laser-transparent, opaque paint material 30, designed as a cover plate 12, is enclosed on all sides by this completely surrounding gap 78. A self-healing polyurethane-based paint material 36 is now supplied via a sprue channel 56 of second cavity 46. It is apparent from the representation according to FIG. 4 that this polyurethane-based self-healing paint material 36 completely encloses free-form optical component 10, which is inserted into second cavity 46 and includes opaque front side 28, since surrounding gap 78 is distributed in a gap width between 0.1 mm and 0.3 mm completely around inserted free-form optical component 10, namely cover plate 12. A spherical shape 40 results, which describes a 180° field of view 38, cover plate 12 including opaque front side 28 being surrounded on all sides by polyurethane-based self-healing paint material 36, thus being completely embedded. After the injection of polyurethane-based self-healing paint material 36, a self-healing paint material 65 applied on both sides results, which completely encloses free-form optical component 10, both on convex curve 58 of opaque front side 28 and on concave curve 60, i.e., on inner side 62 of cover plate 12. Polyurethane-based self-healing paint material 36 itself is formed in a third layer thickness 72, which results from the gap width of surrounding gap 78. This is in the order of magnitude between 0.1 mm and 0.3 mm.

Moreover, it may result from FIG. 4 that polyurethane-based self-healing paint material 36 also completely encloses surrounds 66, which are located at the ends of cover plate 12. Upon the insertion of free-form optical component 10, formed as cover plate 12, into first cavity 44 according to FIG. 3, tempering of cover plate 12 is carried out to dissipate tension. First cavity 44 of two-cavity painting tool 42 is also manufactured with the aid of an ultra-precision machining process with respect to the processing of mold inserts 22, 24.

The filling shown in FIG. 3 of one-sided gap 76 using laser-transparent, but opaque paint material 30 may contain a mixture made up of pigmented polyol and isocyanate, which is injected at low filling pressure into one-sided gap 76 according to FIG. 3, and may also enclose, for example, a heating wire mesh or films including printed-on heating wires. Rapid cross-linking of the plastic material takes place via a tool temperature which is between 140° C. and 180° C., so that opaque front side 28 including high infrared transparency for a laser radiation source on free-form optical component 10 results on outer side 26. After the curing of opaque front side 28 on free-form optical component 10, parting plane 48 is opened and free-form optical component 10 provided with opaque front side 28 is transferred with a coloration unit from first cavity 44 into second cavity 46 of two-cavity painting tool 42 shown in FIG. 4. The two mold inserts 22, 24 are also manufactured here by ultra-precision machining methods in such a way that gap 78 completely surrounding free-form optical component 10 including opaque front side 28 results in the gap width between 0.1 mm and 0.3 mm. Polyurethane-based, self-healing, clear paint material 36 is injected into surrounding gap 78 via sprue channel 56 according to FIG. 4 and also chemically cross-linked at a tool temperature which is preferably between 140° C. and 180° C.

A cover plate 12 thus results in a few process steps, which includes an opaque front side 28, the possible scratches of which on the inner side and the outer side 62, 64 are eliminated in a self-healing manner by supplying heat and the uniform surfaces produce a clear view for a laser radiation source.

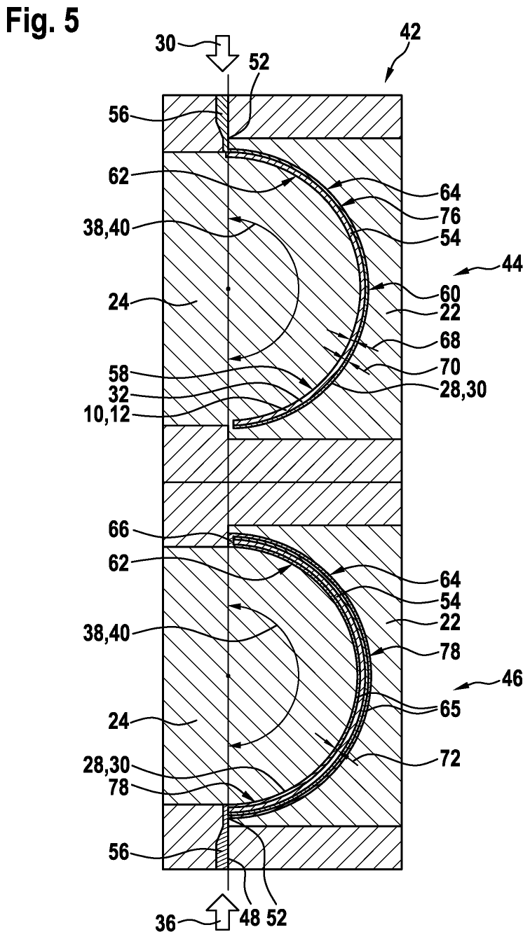

Finally, a schematic diagram of a complete two-cavity painting tool is apparent in FIG. 5.

It is clear from the representation according to FIG. 5 that in two-cavity painting tool 42 shown therein, first cavity 44 is situated above second cavity 46. While laser-transparent, but opaque paint material 30 is injected via sprue channel 56 into one-sided gap 76 in first cavity 44, in second cavity 46 situated below first cavity 44, for example, the injection of clear polyurethane-based self-healing paint material 36 takes place via sprue channel 56 situated on the lower side of second cavity 46. Therefore, in two-cavity painting tool 42, shown completely in FIG. 5, both cavities 44, 46 may be operated simultaneously using different process steps, namely method step b) and method step c), so that a parallel tool usage may be achieved. FIG. 4 shows that the two free-form optical components 10 provided as cover plates 12 or transparent carrier plates 54 cover a 180° area 38 and have an essentially spherical shape 40. The gap width of one-sided gap 76 at first cavity 44 is determined by the geometry of mold inserts 22 and 24 inserted therein, while as already mentioned above in conjunction with FIG. 4, the geometry of surrounding gap 78, which accommodates free-form optical component 10 including opaque front side 28 in second cavity 46, is in the area between 0.1 mm and 0.3 mm. Therefore, nozzle-side mold inserts 22 and ejector-side mold inserts 24 used at first cavity 44 or second cavity 46 of two-cavity painting tool 42 are different, which is true due to the geometry of the particular gap widths either for laser-transparent, opaque paint material 30 applied on one side or for clear polyurethane-based self-healing paint material 36.

Second layer thickness 70 of laser-transparent opaque paint material 30 and third layer thickness 72 of clear polyurethane-based self-healing paint material 36 result from the gap widths in which one-sided gap 76 and surrounding gap 78 are implemented in second cavity 46.

The present invention permits the manufacture of a free-form component 10 including an opaque front side 28 in the form of a cover plate 12 or a transparent carrier plate 54, in which possible scratches on inner side 62 and on outer side 64 may be reformed in a self-healing manner by supplying heat and uniform surfaces may be created for a laser radiation source.

The method provided according to the present invention may be used in particular for manufacturing free-form optical components 10, whether cover plates 12 for LIDAR sensors or transparent carrier plates 54 for other sensors, in order to obtain weather-resistant, soiling-insensitive, and scratch-insensitive covers for sensor systems, which are gaining increasing importance in the automotive field for driver assistance systems or for automated or autonomous driving.

The present invention is not restricted to the exemplary embodiments described here and the aspects highlighted therein. Rather, a variety of modifications, which are routine measures for the expert, are possible within the scope of the present invention.

1-12. (canceled)

13. A method for manufacturing a free-form optical component in an injection unit and a painting tool including at least one cavity, the method comprising the following steps:
a) manufacturing the free-form optical component as a cover plate by injection molding or injection embossing a transparent plastic material in the injection unit;
b) introducing a laser-transparent, opaque paint material into a one-sided gap between the cover plate and a boundary of a first cavity of the painting tool;
c) turning the cover plate treated according to step b) into a second cavity of the painting tool and introducing a self-healing paint material into the second cavity in such a way that a gap surrounding the cover plate treated according to step b) is completely filled by the self-healing paint material and surrounds the free-form optical component within the second cavity.

14. The method as recited in claim 13, wherein in step a), a standard thermoplastic, or a polycarbonate (PC), or a polymethyl methacrylate (PMMA), or a styrene-acrylonitrile copolymer (SAN), is the transparent plastic material.

15. The method as recited in claim 13, wherein the free-form optical component is manufactured for a 180° field of view and is essentially free of tension.

16. The method as recited in claim 13, wherein the laser-transparent, opaque paint material introduced according to step b) adheres on a later outer side of the free-form optical component or a wire mesh or a heating film.

17. The method as recited in claim 13, wherein the laser-transparent, opaque paint material introduced according to method step b) is chemically cross-linked by supplying heat or UV radiation.

18. The method as recited in claim 13, wherein in step c), a clear polyurethane paint which is self-healing upon a supply of heat is the self-healing paint material.

19. The method as recited in claim 18, wherein in step c), the clear polyurethane paint which is self-healing upon the supply of heat is injected completely around the free-form optical component including an opaque outer side, which is manufactured from transparent plastic material.

20. The method as recited in claim 13, wherein the one-sided gap extends in a gap width between 0.1 mm and 0.3 mm between an outer side of the free-form optical component and a surface of a nozzle-side mold insert.

21. The method as recited in claim 13, wherein after curing of the opaque paint material at an outer side of the free-form optical component, the free-form optical component is turned into the second cavity of the painting tool.

22. The method as recited in claim 20, wherein the gap surrounding the free-form optical component turned into the second cavity surrounds it in relation to the nozzle-side mold insert and an ejector-side mold insert in a gap width between 0.1 mm and 0.3 mm.

23. The method as recited in claim 18, wherein the clear self-healing polyurethane paint is injected on both sides of the free-form optical component into the gap surrounding it and is chemically cross-linked at a temperature between 140° C. and 180° C.

24. A free-form optical component for protecting a sensor from weather influences, and/or stone impact, and/or soiling, the free-form optical component being manufactured in an injection unit and a painting tool including at least one cavity, the free-form optical component being manufactured by:
a) manufacturing the free-form optical component as a cover plate by injection molding or injection embossing a transparent plastic material in the injection unit;
b) introducing a laser-transparent, opaque paint material into a one-sided gap between the cover plate and a boundary of a first cavity of the painting tool;
c) turning the cover plate treated according to step b) into a second cavity of the painting tool and introducing a self-healing paint material into the second cavity in such a way that a gap surrounding the cover plate treated according to b) is completely filled by the self-healing paint material and surrounds the free-form optical component within the second cavity.
